(19) United States
(12) Patent Application Publication
(10) Pub. No.: US 2003/0000331 A1
(43) Pub. Date: Jan. 2, 2003

(54) Housing for a bicycle shifter

(76) Inventor: Georg K. Blaschke, Bayern (DE)

Correspondence Address: SRAM CORPORATION, 1333 N. KINGSBURY, 4TH FLOOR, CHICAGO, IL, 60622, US

(21) Appl. No.: 10/064,326

(22) Filed: Jul. 2, 2002

(30) Foreign Application Priority Data
Jul. 2, 2001 (DE) 10132000.0

(51) Int. Cl. F16C 1/12

(52) U.S. Cl. 74/501.6

(57) ABSTRACT

A housing for an actuation device for a bicycle gearing system includes at least one housing element and an installation opening. A closure member covers the installation opening. The closure member is integral with the housing element. The combined housing and closure member is particularly advantageous in terms of installation, maintenance, and reliability. It moreover opens up possibilities for cost savings in tool design and production.

### BACKGROUND OF INVENTION

The present invention relates to bicycle shifters and more particularly to a bicycle shifter having a closure member that is integral with a housing of the shifter.

It is known in the art to provide bicycle shifters to manually shift gearing systems. The bicycle shifters are connected to the gearing system by a transfer element such as a flexible sheathed cable. A manual bicycle shifter may be used on bicycles having an internal gear hub or a derailleur. An example of a manual bicycle shifter is a twist-grip shifter mounted about the handlebar. This type of shifter generally includes, in addition to the actual movable actuation element, a housing, fixedly attached on the bicycle handlebar. The housing contains a mechanism for transferring the actuation motion from the actuation element to the transfer element such as a sheathed cable.

The housing of this type of shifter is substantially closed except for a passthrough opening for the sheathed cable and an aperture for movable reception of the actuation element in order to prevent the penetration of dirt or moisture into the transfer mechanism contained in the housing. The housing of the shifter must also include at least one further opening through which a free end of the sheath cable may be introduced into the shifting cable receptacle of the transfer mechanism. This is necessary to allow initial installation of the shifter on the bicycle or when the sheathed cable is later replaced as a result of wear. This cable replacement opening or installation opening should be closed off with a suitable closure member after the sheathed cable has been threaded through in order to prevent any penetration of dirt or moisture through the installation opening into the transfer mechanism of the bicycle shifter during operation of the shifter.

DE 1 9922327 A1 discloses a housing for a shifter on a bicycle in which the installation opening for the sheathed cable may be closed off by a closure member produced from an elastomeric material. To prevent the closure member from becoming lost, the closure member is attached to the shifter housing by an extension. This closure member has an articulation point in the form of a film hinge or elastomer articulation, making it possible for the closure member attached to the shifter housing to be opened and closed.

One problem associated with this type of closure member is that an additional individual part is needed, resulting in additional tooling, material, production and installation costs. Since the known closure member must be produced from an elastomer material and includes a film hinge or elastomer articulation, handling difficulties often occur with this type of closure member when closing the installation opening. The handling difficulties result from the small size of the closure members, but in particular result from the inaccurate positioning of the closure member relative to the edges of the installation opening due to the type of material and configuration of the closure member.

Therefore, there is a need to provide a housing for a bicycle shifter that has means to close the installation opening while reducing tooling, production and/or installation costs for the closure member. Also, there is a need to provide a configuration of a closure member that ensures exact positioning of the closure member relative to the housing.

### SUMMARY OF INVENTION

The present invention provides a housing for a bicycle shifter The housing includes an installation opening that may be covered or closed with a closure member. In contrast to the existing art, the housing of the present invention does not include a separate part for the closure member rather the closure member is integral with at least one housing element. Such a configuration allows the closure member and the housing element to be produced with the same tool and in the same operation. Additionally, an integral configuration eliminates the installation of the closure member and tolerances relating to the position of the closure member relative to the housing element and relative to the installation opening.

Bicycle shifter housings are generally made of a plastic material whose shaping is accomplished in an injection-molding process. According to the present invention, the shape, contour or wall thickness of the closure member which also includes the housing are immaterial. According to one embodiment of the present invention, however, the closure member has a substantially planar configuration such as a substantially flat surface or a three-dimensional curved surface. According to another embodiment of the present invention, the closure member exhibits a substantially constant thickness over its entire surface. When the closure member has a substantially planar configuration and a substantially constant thickness over its entire surface, costs of tool design and production are reduced.

The type of material used to make the closure member is not essential to the invention. However, preferably the closure member is made of a thermoplastic material that can be processed by the injection-molding method. According to one embodiment of the present invention, the closure member is made of any material that may exhibit mechanical properties ranging from viscoplastic to hard-rubber. The advantage of manufacturing the closure member from any material having properties ranging from viscoplastic to hard-rubber is that the demands of stability and rigidity placed on the shifter are met while still having a certain resilience needed for opening and closing the closure member.

The opening and closing of the closure member is additionally facilitated by the shape and configuration of a flexural region of the closure member. The flexural region may possess many different shapes and configurations. For example, the closure member may be equipped with an elastomer articulation or a film hinge that facilitates lifting of the closure member away from the installation opening. According to one embodiment of the present invention, the closure member has a flexural region of substantially planar configuration. A substantially planar configuration is more robust, rigid and capable of carrying greater loads than a film hinge or elastomer articulation which is of linear shape and moreover often has a very thin wall thickness. The service life, load-carrying capacity, and positioning accuracy of the closure member in the region of the installation opening can be considerably improved with a closure member having a planar flexural region.

According to another embodiment of the present invention, the closure member may have a catch element or snap element in the region of the installation opening that may be brought into latching engagement with a housing recess. The housing recess has a shape complementary to the shape of the catch element that is arranged in the region of the installation opening or is constituted by the installation opening itself. Such a configuration prevents undesirable opening of the closure member due to vibration or hand contact. In another embodiment, the catch element has a hook or sawtooth-shaped configuration and the housing recess is an undercut having a complementary shape to the hook or sawtooth-shaped catch element or snap element.

According to another embodiment of the present invention, the catch element or snap element may be brought out of and/or into engagement with the housing recess by the fact that the catch element or snap element is subjected to a flexural deformation. The flexural deformation of the catch element or snap element is brought about, for example, by the fact that a snap-lock edge of the catch element or snap element slides off along a corresponding snap-lock tab of the undercut that is complementary in shape to the catch element or snap element.

According to another embodiment of the present invention, the catch element may be brought out of and/or into engagement with the undercut by a deformed flexural region of the closure member arranged in the vicinity of the catch element. The inclusion of the flexural region of the closure member allows the rigidity and retaining forces of the catch element to be enhanced without the occurrence of excessive material elongations in the region of the catch element that might negatively affect the service life of the catch join or snap join.

According to a further embodiment of the invention, the closure member exerts at least a slight surface pressure on the housing in the region of the installation opening. Such a configuration allows for a good closure and sealing effect of the closure member, even if the closure member is not equipped with a catch join or snap join for closing off the installation opening. Further with such a configuration not only does the closure member snap or spring back into a closed position after release that the region of the closure member for the installation opening snaps or springs back into the closed position after release (due to the elastic preload of the flexural region of the closure member), but that in the closed position, a residual force additionally presses the part of the closure member onto the rim of the installation opening. This can be achieved by the fact that the closure member already receives, when it is originally shaped, a radius of curvature such that after assembly of the shifter housing, the closure member already possess a certain slight preload in its closed position.

According to another embodiment of the present invention, the closure member includes, in the region of the installation opening, a recess or a projection that allows placement of an opening tool such as a screwdriver, a coin or even a fingernail. The recess or projection may be configured such that the opening tool may be placed into the recess or onto the projection to lift the closure member

The number of parts the housing includes is not essential to the invention. The housing may only include one single housing part which includes the closure member.

Preferably, the housing possesses, in addition to the closure member, at least one second housing element. The closure member is connected to the second housing element by an insertion device, catch device or snap device. The second housing may be manufactured from a particularly rigid or impact-resistant material, whereas the closure member and a portion of the housing may be produced from a viscoplastic to hard-rubber material that meets the requirements of the closure member. Preferably, the insertion device, catch device or snap device detachably joins the closure member with the housing element. As a result, the closure member can be completely separated from the second housing element when, for example, if access to the actuation mechanism becomes necessary for a repair or in order to lubricate the transfer mechanism of the actuation device.

These and other features and advantages of the invention will be more fully understood from the following description of certain specific embodiments of the invention taken together with the accompanying drawings.

### BRIEF DESCRIPTION OF DRAWINGS

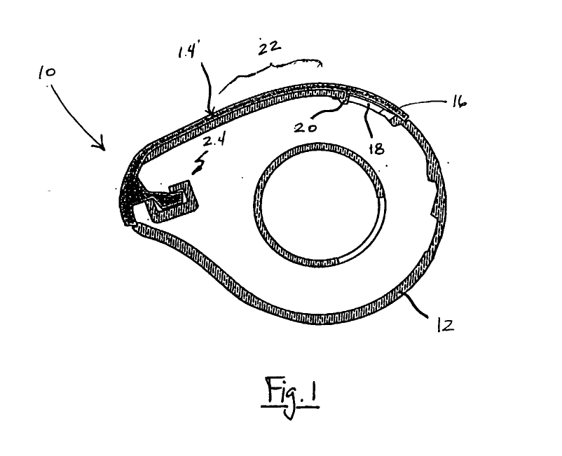

In the drawings, FIG. 1 is a cross-sectional view of a housing for a gear shifting system in accordance with one embodiment of the present invention.

### DETAILED DESCRIPTION

FIG. 1 illustrates one embodiment of the present invention. A housing 10 of a bicycle shifter for a bicycle gearing system depicted in the FIG. 1 generally includes two plastic elements, namely a first housing element 12 and a second housing 14. The first housing element 12 may be made of a hard but impact, resistant plastic material and substantially assumes the supporting housing functions. The second housing element 14 may be made from a material with viscoplastic to hard-rubber properties. The second housing element 14 may extend (out of the plane of the drawing) over larger regions of the shifter housing, or larger regions of the shifter housing may be made up of a closure member 16.

For replacement of the Bowden cable, the first housing element 12 possess a sheathed cable replacement opening or installation opening 18 that is normally covered or closed off by the closure member 16. In the interest of reliable and sealed closure of installation opening 18 during normal operation of shifter, the closure member 16 possesses a catch element 20 that can be brought into closing engagement with an edge of installation opening 18. Additionally or alternatively to a catch element or snap element 20, closure member 16 can also exert, in the region of installation opening 18 a certain surface pressure on housing element 12. The surface pressure can be generated, for example, by the fact that the closure member 16 receives, upon the original shaping of the closure member 16, a radius of curvature smaller than that corresponding to the outside diameter of the housing element 12.

In contrast to the closure members for shifter housings known from the existing art, which are movably joined to the shifter housing either by means of a flexural feature or by means of a film hinge or elastomer articulation, the closure member 16 of the shifter housing comprises a flexural region 22 of substantially planar extension that additionally combines the advantage of easy flexural mobility with high fatigue strength and, in particular, with particularly exact positioning of closure member 16. This means, in other words, that when installation opening 18 is opened and when closure member 16 is lifted away from the installation opening 18, the entire flexural region 22 experiences an elastic flexural deformation that, with suitable dimensioning, results in simple, automatic reclosure of the installation opening as flexural region 22 deforms elastically back.

In one embodiment of the present invention, the closure member 16 is joined to a second housing element 14 by an insertion device, catch device, or snap device 24. The assembly direction of the device 24 may extend perpendicular to the drawing plane. The insertion device, catch device, or snap device 24 can be configured detachably so that the closure member 16 can be completely removed, for example for the purpose of servicing the shifter mechanism (not shown) accommodated in the shifter housing.

It is clear as a result that a shifter housing in which the housing and closure functions as combined in a single integral element makes possible advantages both in terms of installation, maintenance, and reliability, and in the form of cost savings for the production of individual parts.

While this invention has been described by reference to several embodiments, it should be understood that numerous changes could be made within the spirit and scope of the inventive concepts described. Accordingly, it is intended that the invention not be limited to the disclosed embodiments, but that it have the fully scope permitted by the language of the following claims.

1. A housing for a bicycle shifter comprising:
at least one housing element;
an installation opening; and
a closure member for covering the installation opening, the closure member integral with the at least one housing element.

2. The housing according to claim 1, wherein the closure member has a substantially planar configuration in the manner of one of a flat surface and a three-dimensional surface.

3. The housing according to claim 1, wherein the closure member has a substantially constant thickness over substantially the entire surface of the closure member.

4. The housing according to claim 1, wherein the closure member is made of a material having viscoplastic to hard-rubber mechanical properties.

5. The housing according to claim 1, wherein the closure member includes at least one substantially planar flexural region.

6. The housing according to clam 1, wherein the closure member has, in the region of the installation opening, a catch element that can be brought into latching engagement with a housing recess configured in a complementary shape to the catch element.

7. The housing according to claim 6, wherein the catch element has a hook or sawtooth-shaped configuration, and the housing recess constitutes an undercut complementary in shape to the catch element.

8. The housing according to claim 6, wherein the catch element may be brought out of and/or into engagement with the housing recess with a flexural deformation.

9. The housing according to claim 8, wherein the flexural deformation of the catch element may be brought about by the sliding of a snap-lock edge of the catch element on a snap-lock tab of the undercut.

10. The housing according to claim 6, wherein the catch element can be brought out of and/or into engagement with the undercut by deformation of a flexural region of the closure member.

11. The housing according to claim 1, wherein the closure member exerts at least a slight surface pressure on the housing in the region of the installation opening.

12. The housing according to claim 1, wherein the closure member comprises, in the region of the installation opening, one of a recess and a projection for placement of an opening tool.

13. The housing according to claim 1, wherein the housing further comprises at least one second housing element, the closure member being joinable to the second housing element by an insertion device.

14. The housing according to claim 13, wherein the insertion device is detachable.
